(19) United States
(12) Patent Application Publication
(10) Pub. No.: US 2009/0273926 A1
(43) Pub. Date: Nov. 5, 2009

(54) CONFIGURABLE LAMP BAR

(75) Inventor: Jia H. Deng, Diamond Bar, CA (US)

Correspondence Address: FSP LLC, P.O. BOX 890, VANCOUVER, WA, 98666, US

(73) Assignee: DM Technology & Energy Inc., Montclair, CA (US)

(21) Appl. No.: 12/431,741

(22) Filed: Apr. 28, 2009

Related U.S. Application Data
(60) Provisional application No. 61/125,944, filed on Apr. 28, 2008.

(51) Int. Cl. F21S 4/00

(52) U.S. Cl. 362/249.02

(57) ABSTRACT

A lamp bar includes a plurality of LEDs positioned along the body, and a rotational mechanism for rotating the body independently of an electrical connection to a power source.

### PRIORITY CLAIM

This application claims priority under 35 USC 119 to U.S. application Ser. No. 61/125,944 filed on Monday, Apr. 28, 2008, which is presently pending, and which is incorporated herein by reference.

### TECHNICAL FIELD

The present disclosure relates to LED lighting technology.

### BACKGROUND

Traditional fluorescent lighting tubes comprise a gaseous medium enclosed in typically brittle glass tubing. Among other limitations, these fluorescent tubes cannot be readily configured to direct light in different directions and angles.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is an illustration of an embodiment of a rotating LED lamp bar.

FIG. 2 is an exploded view of an embodiment of a rotating LED lamp bar.

FIG. 3 is a perspective view of an embodiment of a rotatable power coupler for a lamp bar.

FIGS. 4 and 5 are illustrations of embodiments of multiple rotating LED lamp bars in various configurations.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout one or more devices, and/or may be comprised of combinations of instructions in memory, processing capability, circuits, and so on. Therefore, in the interest of clarity and correctness logic may not always be distinctly illustrated in drawings of devices and systems, although it is inherently present therein.

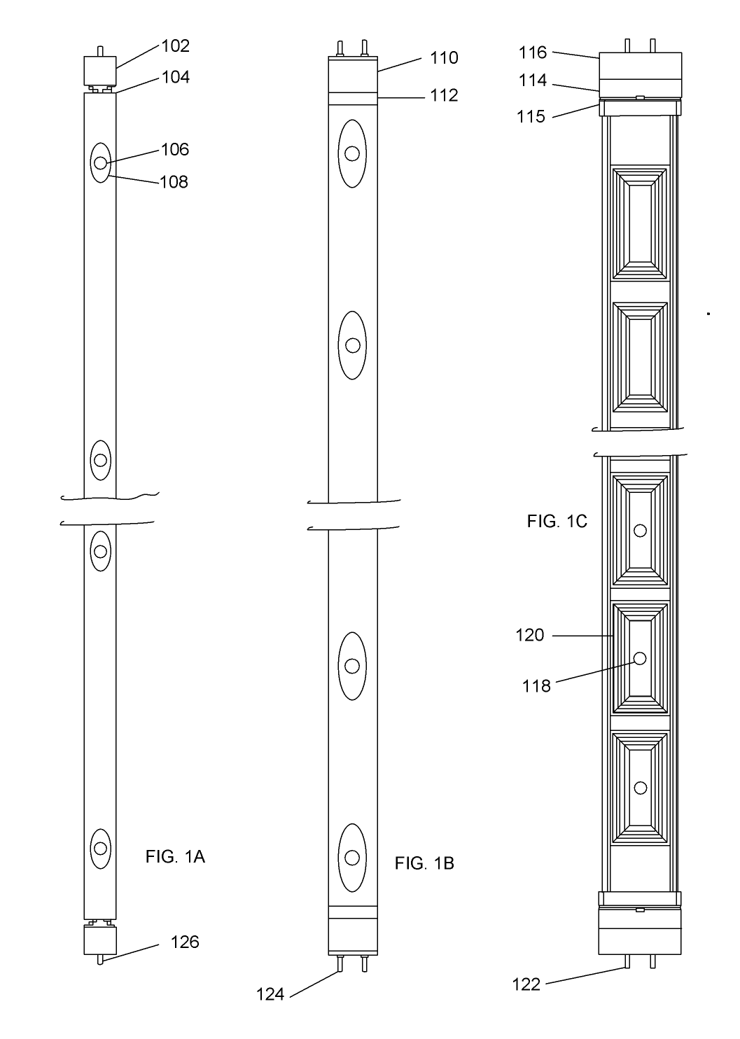

FIG. 1 is an illustration of an embodiment of a rotating LED lamp bar. Typically, direct current enters one end of the bar and exits the other, although in some cases the electricity may enter and leave the same end (e.g. applications where one end of the bar “floats”). In between, the current is applied to multiple LEDs set in recesses in an extruded aluminum housing (for example). The electrical couplers on the end remain fixed in position, while the lamp bar body may rotate 180 degrees or more via rotating couplers between the electrical couplers and the lamp bar body. In this manner light from the lamp bar may be directed in configurable directions.

FIG. 1A is an illustration of an embodiment of a configurable LED lamp bar. The embodiment of FIG. 1A comprises a narrow tubular profile with LEDs 106 located along the length of the bar, within light directing apertures 108. An internal or external power source converts AC power to DC power which is provided through the coupling 102 which has a rotatable coupling 104 to the bar. AC or DC power is provided via power pins 126.

FIG. 1B is an embodiment of a thicker profile lamp bar with an integrated driver. AC power is provided via power pins 124 to couplings 110 which comprise AC to DC LED driver logic. The coupling 110 has rotational coupling 112 to the bar.

FIG. 1C is an embodiment of a lamp bar with a square rectangular down-facing cross section. A driver portion 116 is coupled via rotational coupling 114 through component 115. Along the bars are spaced LEDs 118 in light directing apertures 120. Pins 122 provide AC power which is converted to DC power by the couplings 116.

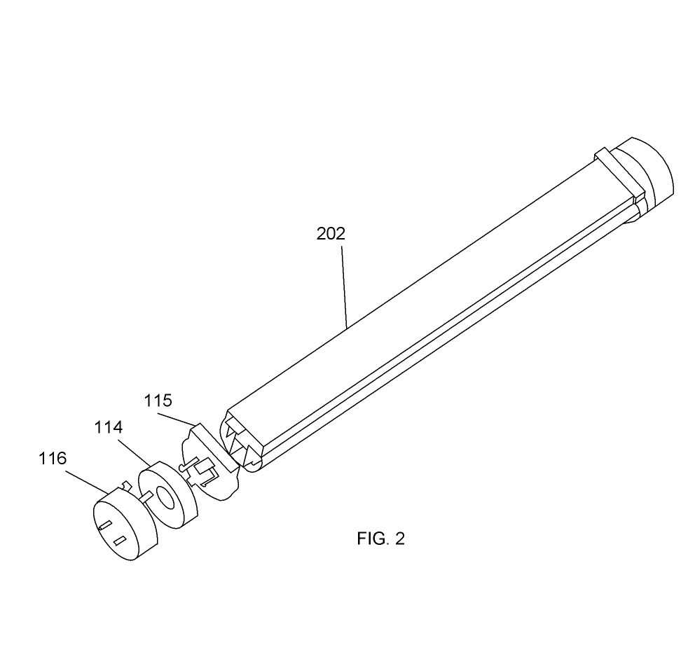

FIG. 2 is an exploded view of an embodiment of a rotating LED lamp bar. The rotating coupler may be configured in various ways, including a friction fit (e.g. rings of slightly compressible materials such as plastic pressed together), a ratchet fit, and other mechanisms. The electrical connection to the LEDs of the lamp bar body is maintained as the body is rotated.

FIG. 2 is a perspective illustration of an embodiment of the lamp bar similar to the one shown in FIG. 1C. The exploded view of FIG. 2 shows how the lamp bar 202 may be coupled to a power supply in a manner that enables the bar to be rotated to direct light in different directions. Note that in this embodiment, power is supplied to only one end of the lamp bar instead of both ends as in the embodiment of FIG. 1C.

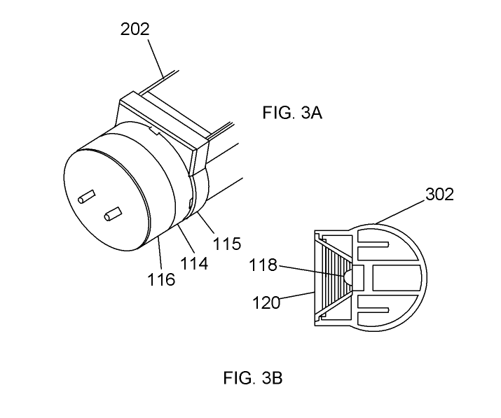

FIG. 3 is a perspective view of an embodiment of a rotatable power coupler for a lamp bar. Also shown is a cross section of an embodiment of a lamp bar body.

FIG. 3A and FIG. 3B show some close-up and cross sectional views of a lamp bar embodiment similar to the one shown in FIG. 1C and FIG. 2. The bar may be formed from aluminum extrusion heat sink 302.

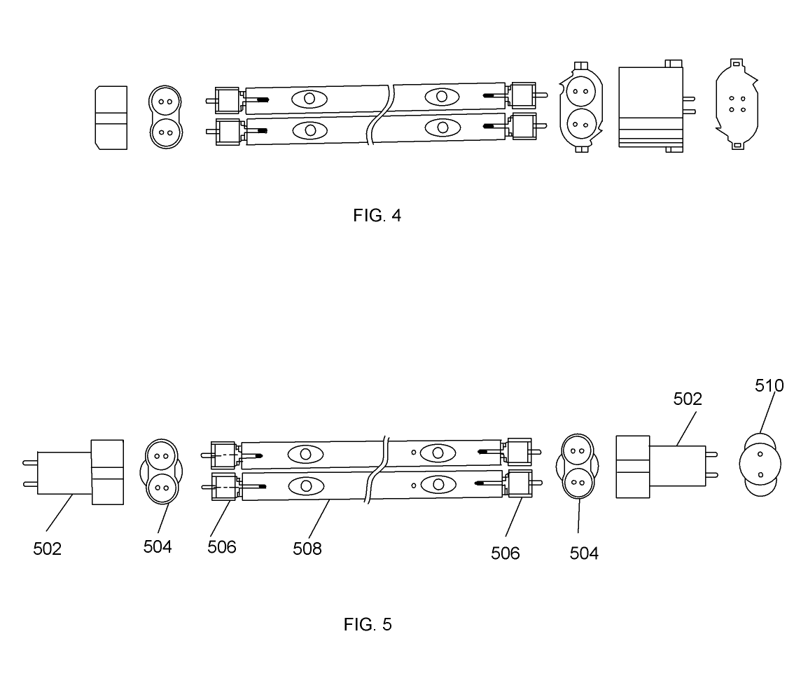

FIGS. 4 and are embodiments of multiple rotating LED lamp bars in various configurations. Each bar body may be rotated independently from the others, providing excellent configurability of lighting dispersal.

FIG. 4 shows an embodiment of a dual LED lamp configuration in which dual lamp bars draw power from one end and are mounted together in a manner in which each may be independently rotated.

FIG. 5 shows another embodiment of a dual lamp configuration in which both lamp bars may be independently rotated. Both ends are coupled via coupling 502 to power source 510. Coupler 504 secures the individual lamp bars in a dual configuration. The rotational coupler 506 provides for independent rotation of the bars 508.

What is claimed is:

1. A lamp bar comprising a plurality of LEDs positioned along the body, and a rotational mechanism for rotating the body independently of an electrical connection to a power source.
